(19) United States
(12) Patent Application Publication
(10) Pub. No.: US 2007/0180255 A1
(43) Pub. Date: Aug. 2, 2007

(54) Information processing apparatus and authentication control method

(76) Inventors: Toru Hanada, Ome-shi (JP); Mayumi Maeda, Ome-shi (JP); Satoshi Tamura, Ome-shi (JP); Terunobu Hara, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/698,386

(22) Filed: Jan. 26, 2007

(30) Foreign Application Priority Data
Jan. 30, 2006 (JP) 2006-021254

(51) Int. Cl. H04L 9/00

(52) U.S. Cl. 713/176

(57) ABSTRACT

According to one embodiment, an information processing apparatus includes a plurality of authentication units, and a setting unit configured to selectively set a first authentication mode and a second authentication mode, the first authentication mode determining a person to be authenticated to be an authenticated person when authentication by any one of the plurality of authentication units succeeds, and the second authentication mode determining the person to be authenticated to be an authenticated person when the authentications by two or more of the plurality of authentication units succeed.

### CROSS-REFERENCE TO RELATED APPLICATIONS

This application is based upon and claims the benefit of priority from Japanese Patent Application No. 2006-021254, filed Jan. 30, 2006, the entire contents of which are incorporated herein by reference.

### BACKGROUND

1. Field

One embodiment of the invention relates to a user authentication technology well adaptable for an information processing apparatus such as a personal computer.

2. Description of the Related Art

Recently, battery-driven portable information processing apparatuses are pervasively used. Examples of those apparatuses are notebook type personal computers and personal digital assistant (PDA) terminals. This type of portable information processing apparatus is reduced in size and weight, and is enhanced in function and increased in memory capacity. Accordingly, the information processing apparatus is capable of performing fairly sophisticated data processing and sometimes stores a large amount of important data.

When the portable information processing apparatus is compared with the stand-alone information processing apparatus, the former has a higher risk that it is stolen than the latter. Recently a large amount of important data is stored in the information processing apparatus, and thus security requirements have become stricter than before.

It is a common practice that a password is entered for authenticating the user. Various types of authentication methods have been proposed in place of the password entry method (for example, refer to U.S. Pat. No. 6,871,063).

The specification of U.S. Pat. No. 6,871,063 discloses a method of controlling a computer system which accepts access to the computer from a mobile phone via public communication lines. The computer system grants an access right to only the mobile phone which is linked for the wireless communication based on the Bluetooth (trade-mark) standards, or the mobile phone previously paired.

If any of such various authentication methods is combined with the password entry method, the security level could be increased.

Use of the information processing apparatus and environment where it is used are different for each user. For some users, it suffices that any of a plurality of authentication methods holds, and for some users, it is essential that all the authentication methods must hold. Accordingly, it is preferable that the user authentication condition is selected for each scene of the use.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of a computer which is an embodiment of the present invention;

FIG. 2 is an exemplary diagram showing a system configuration of the computer of the embodiment;

FIG. 3 is an exemplary diagram for explaining an authentication process to be executed by the computer of the embodiment;

FIG. 4 is an exemplary diagram showing a setting screen displayed by an authentication mode setting-utility module of the computer of the embodiment;

FIG. 5 is an exemplary flowchart showing operational procedures of a user authentication process executed by the computer of the embodiment; and

FIG. 6 is an exemplary flowchart showing a modification of a setting screen displayed by the authentication mode setting-utility module in the computer of the embodiment.

### DETAILED DESCRIPTION

Various embodiments according to the invention will be described hereinafter with reference to the accompanying drawings. In general, according to one embodiment of the invention, an information processing apparatus includes a plurality of authentication units, and a setting unit configured to selectively set a first authentication mode and a second authentication mode, the first authentication mode determining a person to be authenticated to be an authenticated person when authentication by any one of the plurality of authentication units succeeds, and the second authentication mode determining the person to be authenticated to be an authenticated person when the authentications by two or more of the plurality of authentication units succeed.

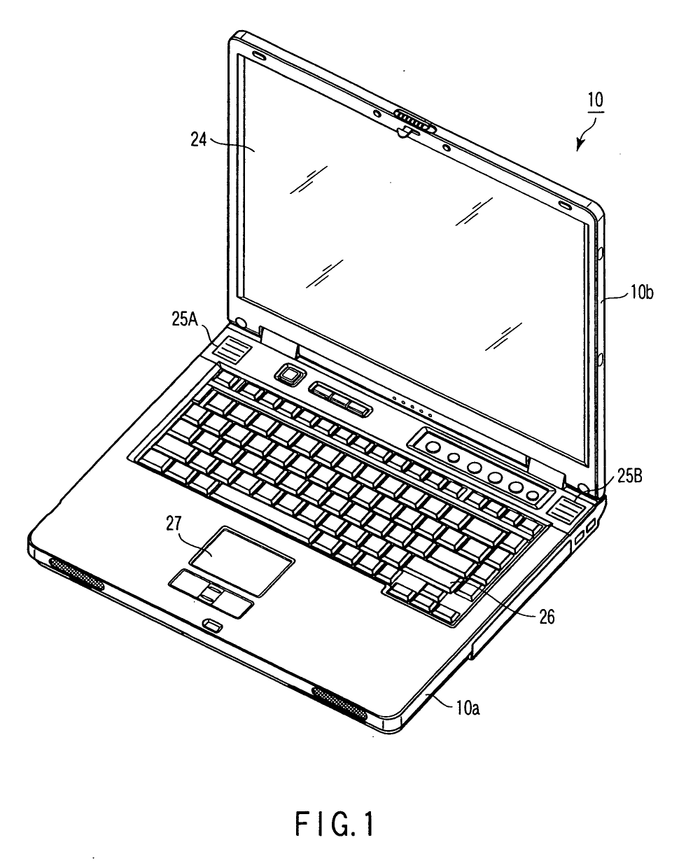

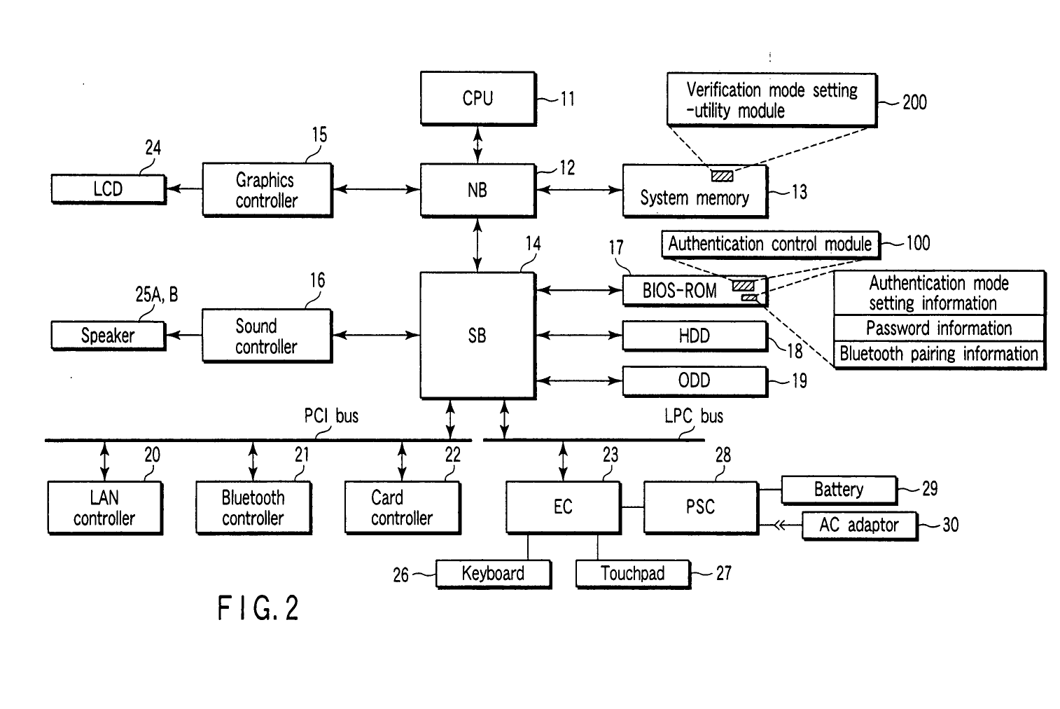

A configuration of an information processing apparatus according to an embodiment of the present invention will be described with reference to FIGS. 1 and 2. The information processing apparatus takes the form of a notebook type personal computer 10 in the embodiment.

FIG. 1 is an exemplary perspective view showing the notebook type personal computer 10 when a display unit thereof is opened. The computer 10 includes a computer body 10a and a display unit 10b. A display device composed of a liquid crystal display (LCD) 24 is assembled into the display unit 10b. A display screen of the LCD 24 is substantially centrally located in the display unit 10b.

The display unit 10b is mounted on the computer body 10a such that it may be turned between an open position and a close position. The computer body 10a has a housing shaped like a thin box. Speakers 25A and 25B, a keyboard 26, a touch pad 27, and the like are arranged on the upper surface of the computer body 10a.

A system configuration of the computer 10 will be described with reference to FIG. 2.

In addition to the LCD 24, the speakers 25A and 25B, the keyboard 26, and the touch pad 27, which are shown in FIG. 1, the notebook type personal computer 10, as shown in FIG. 2, includes a CPU 11, a north bridge 12, a system memory 13, a south bridge 14, a graphics controller 15, a sound controller 16, a BIOS-ROM 17, a hard disk drive (HDD) 18, an optical disk drive (ODD) 19, a LAN controller 20, a Bluetooth controller 21, a card controller 22, an embedded controller 23, a power source controller 28, and the like.

The CPU 11 is a processor provided for controlling operations of the computer 10. The CPU 11 executes an operating system (OS) and various application programs, which is loaded from the HDD 18 to the system memory 13, such as an authentication mode setting-utility module 200 to be described later. The CPU 11 also executes various modules, including a basic input-output system (BIOS) stored in the BIOS-ROM 17. The BIOS is a program for hardware control. A authentication control module 100 is also stored in the BIOS-ROM 17. The authentication control module 100 is a program which is started upon power on, executes an authentication process for authenticating validity of a user, and when the authentication is successfully made, starts an operating system.

The north bridge 12 is a bridge device interconnecting a local bus of the CPU 11 and the south bridge 14. The north bridge 12 also contains a memory controller for controlling access to the system memory 13. The north bridge 12 also has a function to communicate with the graphics controller 15.

The graphics controller 15 as a display controller for controlling the LCD 24 generates display signals to be sent to the LCD 24, from the image data written into a video memory (VRAM).

The south bridge 14 controls various devices on a Low Pin Count (LPC) bus and a Peripheral Component Interconnect (PCI) bus. Also, the south bridge 14 contains an Integrated Drive Electronics (IDE) controller for controlling the HDD 18. The south bridge 14 has a function to control access to the BIOS-ROM 17, and another function to execute the communication with the sound controller 16.

The HDD 18 is a storage device for storing various types of software and data. The ODD 19 is a drive unit for driving a memory media such as a DVD having stored therein video content. The sound controller 16 is provided for outputting sound from the speakers 25A and 25B.

The LAN controller 20 performs wired communication according to Ethernet (trade-mark) standards, and the Bluetooth controller 21 performs wireless communication according to Bluetooth standards. The card controller 22 executes access to such a memory card as an SD card.

The embedded controller 23 is a one-chip microcomputer containing a keyboard controller for controlling the keyboard 26 and the touch pad 27. The embedded controller 23 has also a function to communicate with the power source controller 28. The power source controller 28 manages a power supply, which receives electric power from a battery 29 or via an AC adaptor 30, and supplies it to related portions.

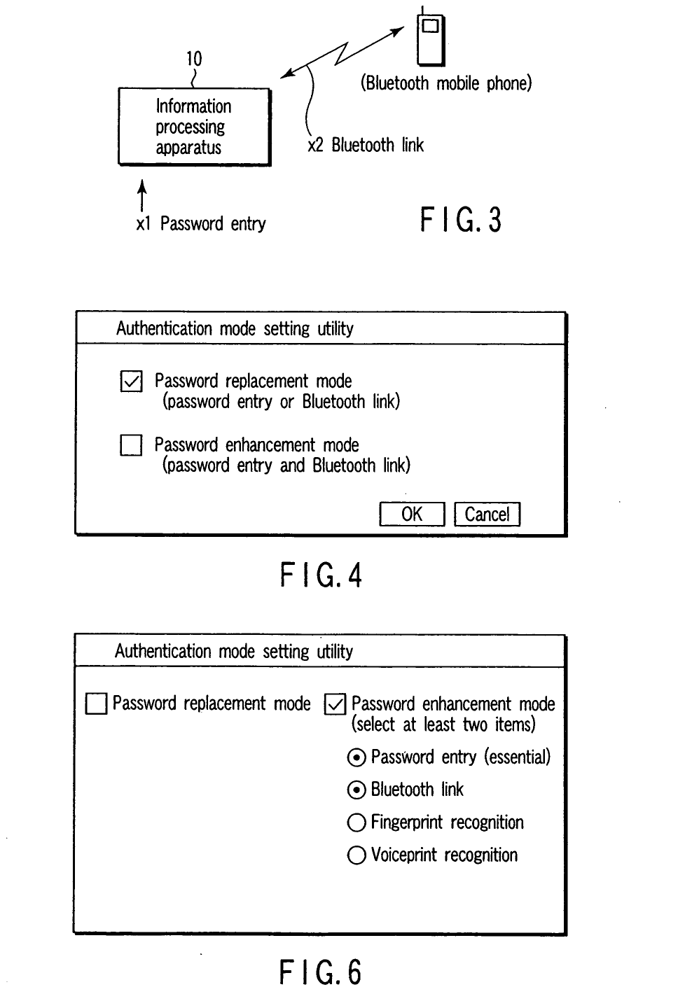

A authentication process of the computer 10, which is executed by the authentication control module 100 stored in the BIOS-ROM 17, will be described with reference to FIG. 3.

The authentication control module 100, which starts upon power on, first executes and controls an authentication process, which responds to a correct password entered from the keyboard 26 and authenticates the validity of a user (x1 in FIG. 3). Then, the authentication control module 100 second executes a confirmation process for confirming the validity of the user by causing the Bluetooth controller 21 to try the link to a previously paired mobile phone, for example, Bluetooth mobile phone (x2 in FIG. 3). In the embodiment, the password information and the Bluetooth pairing information, which are used for those two authentication processes, are stored in the BIOS-ROM 17. It will be understood that the storage of those pieces of information is presented by way of example without being limited thereto.

The personal computer 10 has two modes: a first mode is such that when either of the two authentication processes succeeds, it is determined that the user is valid, and a second mode is such that when both the authentication processes succeed, it is determined that the user is valid. These two modes are selectively used in accordance with a scene of the use of the computer. In the specification, the first mode will be referred to as a password replacement mode and the second mode will be referred to as a password enhancement mode. In the password replacement mode, the authentication is made to succeed by the Bluetooth link in place of the entry of the password. In the password enhancement mode, the Bluetooth connection is required for the user authentication, in addition to the entry of the password.

The authentication mode setting-utility module 200 is used for setting the function of the password replacement mode or the password enhancement mode. When the authentication mode setting-utility module 200 is started, a setting screen is displayed as shown in FIG. 4.

The user can select and set his/her desired authentication mode by merely checking a check box of the password replacement mode or the password enhancement mode and pressing an OK button. Upon the operations, the authentication mode setting-utility module 200 stores the set content as authentication-mode setting information into the BIOS-ROM 17. In the embodiment, the authentication-mode setting information, like the password information and the Bluetooth paring information described above, is stored in the BIOS-ROM 17, which is a mere example and the invention is not limited thereto. The authentication control module 100 executes and controls the user authentication process in accordance with the authentication-mode setting information.

Since the password replacement mode and the password enhancement mode can be selectively used, the user can make appropriate use of the computer 10 in the following manner.

When a user has a previously paired mobile phone, the user desires to achieve the authentication without entering the password. Accordingly, the user selects and sets the password replacement mode. Another user desires to add the fact that the user has the mobile phone to the authentication success condition. Accordingly, the user selects and sets the password enhancement mode.

In another case where a stand-alone electronic apparatus located in a user's home or office has been selected as a partner apparatus to be Bluetooth linked, the user desires to omit the entry of the password when the user is in his/her home or office. Accordingly, the user selects the password replacement mode. Another user desires to prohibit the apparatus from being used outside the home or office. Accordingly, the user selects the password enhancement mode.

In this way, the user can set up the authentication mode according to a scene of the use.

When the password enhancement mode is set up, even if a user fails to set up the Bluetooth link, the authentication control module 100 does not inform the user of its failure and prompts the user to continue the entry of the password. At this time, the authentication control module 100 informs the user of the failure of the password entry and causes the user to repeat the password entry operation given times, regardless of whether the entered password is correct or not. In a case where a doubtful person who surreptitiously obtained a password steals the computer in which the password enhancement mode has been set up and turns on the power switch at a remote location, that person fails to make the authentication not because the password entered is not incorrect, but because the Bluetooth link is not set up. However, that person mistakenly understands it as if the computer has rejected his/her access to the computer at the stage of entering the password. Further, the fact that success in setting up the Bluetooth link is one of the authentication conditions is concealed from that person.

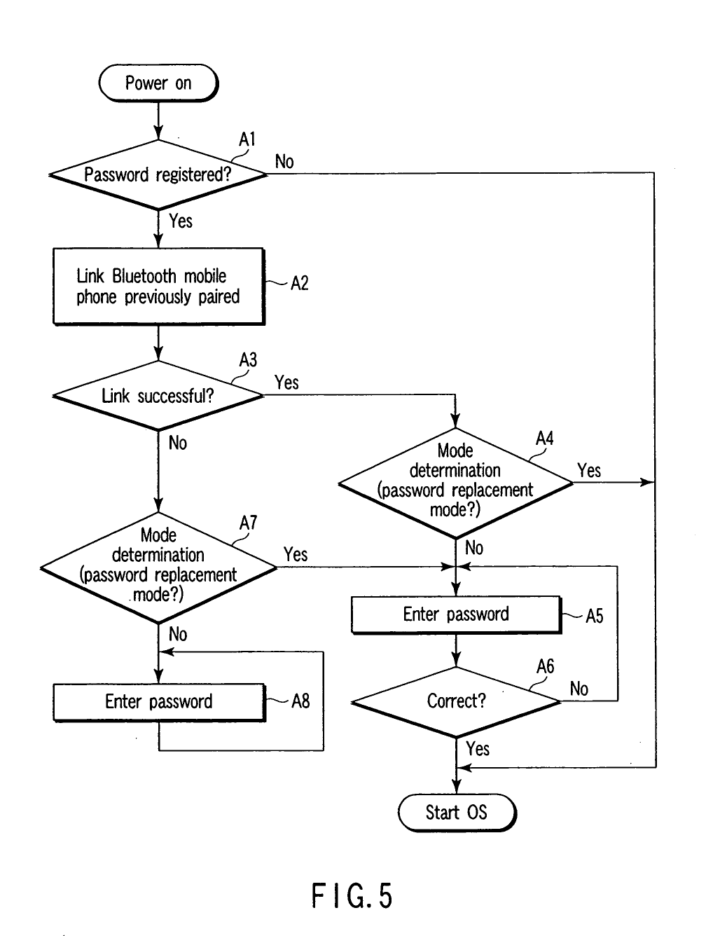

FIG. 5 is an exemplary flowchart showing operational procedures flow of a user authentication process executed by the computer 10.

Upon power on, the authentication control module 100 checks whether or not a password has been registered in the computer (block A1). If not registered (NO in block A1), the authentication control module 100 unconditionally starts the operating system. If the password has been registered (YES in block A1), the authentication control module 100 causes the Bluetooth controller 21 to execute the process for setting up the link to a Bluetooth mobile phone previously paired with the computer (block A2).

If the Bluetooth link is set up (YES in block A3), the authentication control module 100 checks whether or not the password replacement mode has been set up (block A4). If the password replacement mode has been set up (YES in block A4), the authentication control module 100 determines to start the operating system depending only on the success in setting up the Bluetooth link, and starts the operating system. If the password enhancement mode has been set up (NO in block A4), the authentication control module 100 waits for input of a password from the keyboard 26 (block A5), and checks if the entered password is correct (block A6). If the entered password is correct (YES in block A6), the authentication control module 100 determines to start the operating system under condition that the user was successful in the Bluetooth linking and the password entry. If the password is incorrect (NO in block A6), the authentication control module prompts the user to retry the entry of the password. The password reentry may be repeated unlimitedly or power may be forcibly shut down after the user fails to make the authentication based on the password entry a predetermined number of times.

When the user fails in setting up the Bluetooth link (NO in block A3), the authentication control module 100 checks whether or not the password replacement mode has been set up (block A7). If the password replacement mode has been set (YES in block A4), the authentication control module waits for input of a password from the keyboard 26 (block A5), and checks whether or not the password is correct (block A6). If the password entered is correct (YES in block A6), the authentication control module 100 determines to start the operating system depending only on the success of the password entry and starts the operating system. If the password is not correct (NO in block A6), the authentication control module causes the user to retry the password entry.

If the password enhancement mode has been set up (NO in block A7), the authentication failure is determined at this time point; however, the authentication control module 100 does not notify the user of the authentication failure and prompts the user to enter the password (block A8). Then, the authentication control module 100 prompts the user to repeat the retry of the password entry action regardless of whether or not the entered password is correct. As already stated, in the case where a doubtful person who surreptitiously obtained a password steals the computer in which the password enhancement mode has been set up and turns on the power switch at a remote location, that person fails to make the authentication not because the password entered is not incorrect, but because the Bluetooth link is not set up. However, that person mistakenly understands it as if the computer has rejected his/her access to the computer at the stage of entering the password. Further, the fact that success in setting up the Bluetooth link is one of the authentication conditions is concealed from that person.

The case where the password entry and the Bluetooth link may be used in OR condition (password replacement mode) or AND condition (password enhancement mode), have been described. It is evident that what is added to the password entry in the password enhancement mode may be any of various authenticating means, such as fingerprint and voiceprint recognitions, without being limited to the Bluetooth link. In an exemplary case, an authentication mode setting-utility program 101 displays a setting screen as shown in FIG. 6. As a result, in the password enhancement mode, the user may select a desired number of items in addition to the password entry. The selection details are stored as authentication mode setting information in the BIOS-ROM 17.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a plurality of authentication units; and
a setting unit configured to selectively set a first authentication mode and a second authentication mode, the first authentication mode determining a person to be authenticated to be an authenticated person when authentication by any one of the plurality of authentication units succeeds, and the second authentication mode determining the person to be authenticated to be an authenticated person when the authentications by two or more of the plurality of authentication units succeed.

2. The information processing apparatus according to claim 1, wherein the setting unit arbitrarily selects authentication unit to be used in the second authentication mode from the plurality of authentication units.

3. The information processing apparatus according to claim 1, further comprising authentication control unit configured to perform such a control that when authentication by the first authentication unit included in the plurality of authentication units fails in the second authentication mode, the person to be authenticated is not informed of the authentication failure by the first authentication unit.

4. The information processing apparatus according to claim 3, wherein the authentication control unit does not inform the person to be authenticated of the authentication failure by the first authentication unit, and instructs the person to be authenticated to perform authentication by second authentication unit included in the plurality of authentication units.

5. The information processing apparatus according to claim 4, wherein the authentication control unit determines that the authentication by the second authentication unit fails irrespective of success or failure of the authentication by the second authentication unit, and informs the person to be authenticated of the failure of the authentication by the second authentication unit.

6. The information processing apparatus according to claim 1, further comprising wireless communication unit,
wherein one of the plurality of authentication units approves authentication when the information processing apparatus is linked to an external electronic apparatus by the wireless communication unit.

7. An information processing apparatus comprising:
an inputting unit;
a wireless communication unit configured to execute wireless communication; and
a setting unit configured to selectively set a first authentication mode and a second authentication mode, the first authentication mode determining a person to be authenticated to be an authenticated person when authentication by first authentication unit or second authentication unit succeeds, the first authentication unit approving authentication when the information processing apparatus is linked to an external electronic apparatus by the wireless communication unit, the second authentication unit approving authentication when a correct password is input by the inputting unit, and the second authentication mode determining the person to be authenticated to be an authenticated person when authentication by the first authentication unit and the second authentication unit succeeds.

8. The information processing apparatus according to claim 7, further comprising authentication control unit, wherein when the authentication by the first authentication unit fails in the second authentication mode, the authentication control unit does not inform the person to be authenticated of the failure of the authentication by the first authentication unit and instructs the person to be authenticated to perform authentication by the second authentication unit, determines that the authentication by the second authentication unit fails irrespective of whether or not a correct password is entered, prompts the person to be authenticated to repeat the reentry of the password a predetermined number of times, and then informs the person to be authenticated of the failure of authentication by the second authentication unit.

9. An authentication control method of an information processing apparatus including a plurality of authentication unit, comprising:
setting a first authentication mode in which a person to be authenticated is determined to be an authenticated person when authentication by any one of said plurality of authentication units succeeds; and
setting a second authentication mode in which, when the first authentication mode is not set up, the person to be authenticated is determined to be an authenticated person when the authentications by two or more of the plurality of authentication unit succeed.

10. The authentication control method according to claim 9, further comprising performing such a control that when authentication by first authentication unit included in the plurality of authentication unit fails in the second authentication mode, the person to be authenticated is not informed of the authentication failure by the first authentication unit.

11. The authentication control method according to claim 10, wherein the performing such the control does not inform the person to be authenticated of the authentication failure by the first authentication unit, and instructs the person to be authenticated to perform authentication by second authentication unit included in the plurality of authentication units.

12. The authentication control method according to claim 11, wherein the performing such the control, after the person to be authenticated is instructed to perform the authentication by the second authentication unit, determines that the authentication by the second authentication unit fails irrespective of success or failure of the authentication by the second authentication unit, and informs the person to be authenticated of the failure of the authentication by the second authentication unit.
